(19) United States
(12) Patent Application Publication
(10) Pub. No.: US 2008/0158259 A1
(43) Pub. Date: Jul. 3, 2008

(54) IMAGE WARPING AND LATERAL COLOR CORRECTION

(75) Inventors: Jeffrey Matthew Kempf, Dallas, TX (US); Rajeev Ramanath, Plano, TX (US); David Foster Lieb, Dallas, TX (US); Henry W. Neal, Allen, TX (US); Arnold P. Skoog, Frisco, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/617,171

(22) Filed: Dec. 28, 2006

(51) Int. Cl. G09G 5/00

(52) U.S. Cl. 345/647

(57) ABSTRACT

Color or grayscale images having optical elements induced geometric distortions can be corrected on individual color image component by creating correction image component having the complementary distortion; and applying the correction image component to the corresponding distorted color image component.

### TECHNICAL FIELD

The technical field of the examples to be disclosed in the following sections relates to the art of display systems and image production, and more particularly, to the art of image processing in display production.

### BACKGROUND

Optics is the key element in current display systems. Low quality or indelicate optics may introduce geometric distortions in produced images. In display systems using a set of elementary colors (i.e. primary colors) to present desired color images, each elementary color image component may have separate distortions; while different color image components may have different distortions. When superimposed to form the desired image, distortions in different color image components are mixed together—resulting in combined distortion in the displayed image.

### SUMMARY

In one example, a method for producing an image using an image producing system is disclosed herein. The method comprises: characterizing a geometric distortion introduced to each image component of the image by the image producing system; creating a correction image component for each image component of the image, wherein said correction image component has a distortion complementary to the geometric distortion in the corresponding image component; and producing the image using the correction image component.

In another example, a computer-readable medium having a set of computer-executable instructions for performing a method for producing an image using an image producing system is disclosed, wherein the method comprises: characterizing a geometric distortion introduced to each image component of the image by the image producing system; creating a correction image component for each image component of the image, wherein said correction image component has a distortion complementary to the geometric distortion in the corresponding image component; and producing the image using the correction image component.

In yet another example, a device for use in an imaging system for correcting a geometric distortion introduced by the imaging system is disclosed herein. The device comprises: an image warping engine capable of creating a correction image component for each image component of the image, wherein said correction image component has a distortion complementary to a geometric distortion in the corresponding image component introduced by the system during imaging.

In still yet another example, a display system for displaying an image is disclosed herein. The system comprises: an image engine having an array of individually addressable pixels; and a control unit comprising a warping engine for creating a correction color image component for each color image component of the image, wherein said correction color image component has a distortion complementary to a geometric distortion in the corresponding color image component introduced by the system during imaging.

### BRIEF DESCRIPTION OF DRAWINGS

FIG. 1a to FIG. 1c schematically demonstrate a method for correcting geometric distortions according to an example of the invention, wherein FIG. 1a illustrates an image having geometric distortions introduced by a display system during displaying; wherein FIG. 1b illustrates a correction image to be displayed by the display system; and FIG. 1c is an image produced by the display system using the correction image in FIG. 1b;

FIG. 2a to FIG. 2c schematically demonstrate a method for correcting another geometric distortions according to an example of the invention, wherein FIG. 2a illustrates an image having geometric distortions introduced by a display system during displaying; wherein FIG. 2b illustrates a correction image to be displayed by the display system; and FIG. 2c is an image produced by the display system using the correction image in FIG. 2b;

FIG. 3 is a block diagram of a display electronic in which examples of the invention is implemented for correcting image distortions introduced by optical elements; and

FIG. 4 schematically illustrates an exemplary display system in which the display electronics of FIG. 3 can be used for correcting image distortions introduced by optical elements.

### DETAILED DESCRIPTION OF SELECTED EXAMPLES

Disclosed herein is a method for correcting geometric distortions introduced by optical elements of the display system used for reproducing the image with the correction being performed on distortions in individual color image component.

Unlike existing image correction solutions that either assume that the geometric distortion is the same for each primary color image component, or that the input and output primary colors perfectly match, the method disclosed herein corrects the distortion for each color image component used in the display system to display the image. Specifically, the distortion in each color image component introduced by the display system used for reproducing the image having the color component is analyzed and characterized. Corresponding to the distorted color image component with the characterized distortion, a pre-distorted correction color image component is generated. Such correction color image component has an opposite distortion that is complementary to the characterized distortion in the corresponding color image component. The corrected color image component is then used for reproducing the desired image. During the image reproduction, the correction image is distorted by the members of the display system, such as the optical elements of the display system. Because the distortion produced by the display system is opposite or complement to the distortion in the corrected image, the final reproduced image appears to be normal.

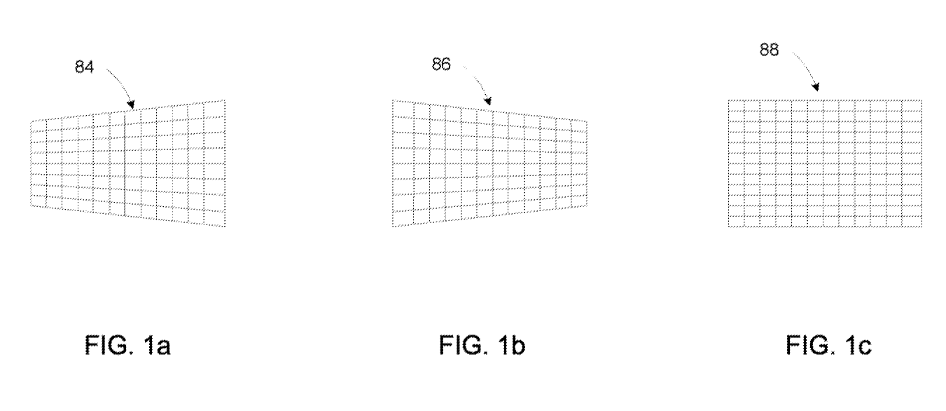

As a way of example, FIG. 1a schematically illustrates a color image component (e.g. a color from red, green, blue, cyan, magenta, yellow, and white) having a geometric distortion that is introduced by a display system during image reproduction without proper image correction. Such distortion can be introduced by optical elements or other members of the display system. For correcting this distortion during the image reproduction, the color component in the desired image to be reproduced is pre-distorted to form a corrected image, as shown in FIG. 1b, based on the distortion characters of the display system (e.g. the distortion character of image 84). Specifically, the pre-distorted correction image, as shown in FIG. 1b, has a distortion that is complementary to the distortion in image 1a. The correction image is then used by the display system to reproduce the color component of the desired image. Because the distortion produced by the display system is opposite or complement to the distortion in the corrected color image component, the final reproduced color image component appears to be normal, as shown in FIG. 1c. The desired image may have multiple color image components, such as red, green, blue, and white color image components. Accordingly, a correction color image component is generated preferably for each color image component in the desired image to be reproduced. All correction color image components are used by the display system to produce the desired image—resulting in a normal color image substantially without distortion.

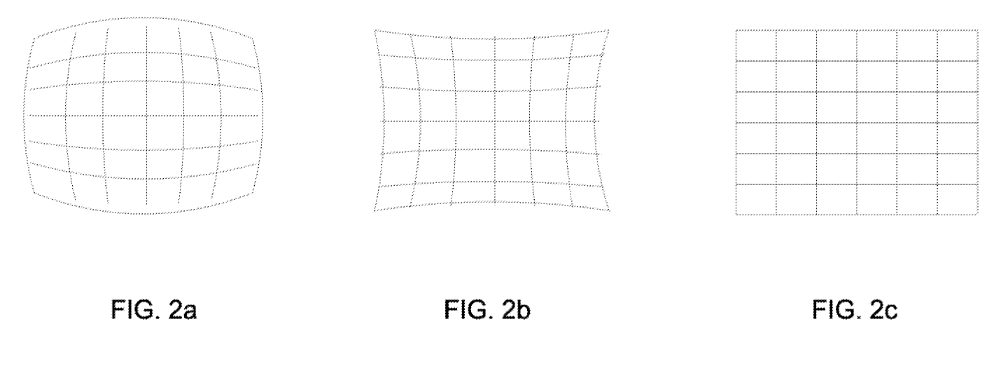

It is noted that FIG. 1a and FIG. 1b as discussed above show only one of many types of geometric distortions that can be corrected. The examples disclosed herein are also applicable to correct many other types of geometric distortions introduced by the display system, such as barrel distortion, as shown in FIG. 2a.

Referring to FIG. 2a, a barrel distortion may be introduced to a color image component of the desired color image by the members of the display system during the image reproduction. For correcting such distortion, a corresponding correction color image component having a pincushion distortion that is complementary to the barrel distortion is generated, as shown in FIG. 2b. During the image reproduction, the corrected color image component experiences the geometric distortion as shown in FIG. 2a. Because the distortion produced by the display system is opposite or complement to the distortion in the corrected color image component, the final reproduced color image component appears to be normal, as shown in FIG. 2c. The above color image correction can be performed for each color component in the desired image. In an example wherein the display system introduces pincushion distortion as shown in FIG. 2b, a barrel correction image as shown in FIG. 2a corresponding to the color image component having the pincushion distortion can be generated and displayed, which results in a normal image without pincushion distortion.

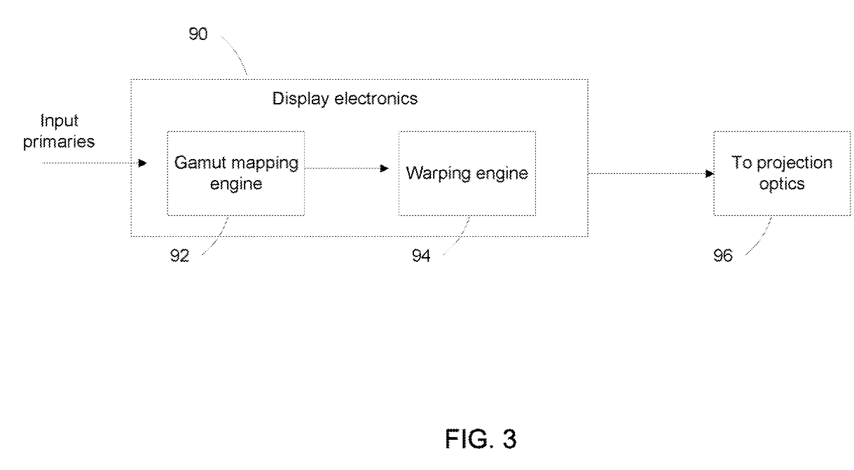

Because the image correction can be performed on each individual color image component, it is preferably performed after other color correction operations, such as gamut mapping or color space conversion. Gamut mapping or color space conversion is a method to modify a representation of a color image to fit into a constrained color space of a given color rendering medium. A projection system attempts to reproduce a color image with a color depth higher than what the display system can display, the display system would have to map the colors of the color image into a color range provided by the display system. In other words, the image color gamut is would have to be mapped into the color gamut of the display system. In existence of such gamut mapping, the image correction can be performed after the gamut mapping, as shown in FIG. 3. More preferably, the image correction can be performed on the images right before being processed for projection, such as before being transformed into bitplane data used in the projection systems.

The examples disclosed herein can be implemented as a standalone software module that comprises a set of computer executable instructions (e.g. program codes) or be implemented in an electronic circuit board, such as the display electronic board (90) as schematically illustrated in FIG. 3. Referring to FIG. 3, display electronic board 90 comprises circuits for performing multiple functions, such as image processing and controlling the display of the desired image. In particular, the display electronic board comprises warping engine 94, in which one of the examples disclosed herein is implemented. It will be appreciated that the warping engine can be a standalone circuit; and the warping engine can be ASIC (stands for Application-Specific Integrated Circuit) or FPGA (stands for Field Programmable-gate-Array), or any other type of electronic circuit. As shown in FIG. 3, the input image is received by the display electronic board; and processed by gamut mapping engine 92 to render the colors appropriately. For each color image component of the input image, warping engine 94 generates a corresponding correction color image component as discussed above with reference to FIG. 1a to FIG. 2c. The correction color image component output from warping engine can then be delivered to other components of a display system for projection.

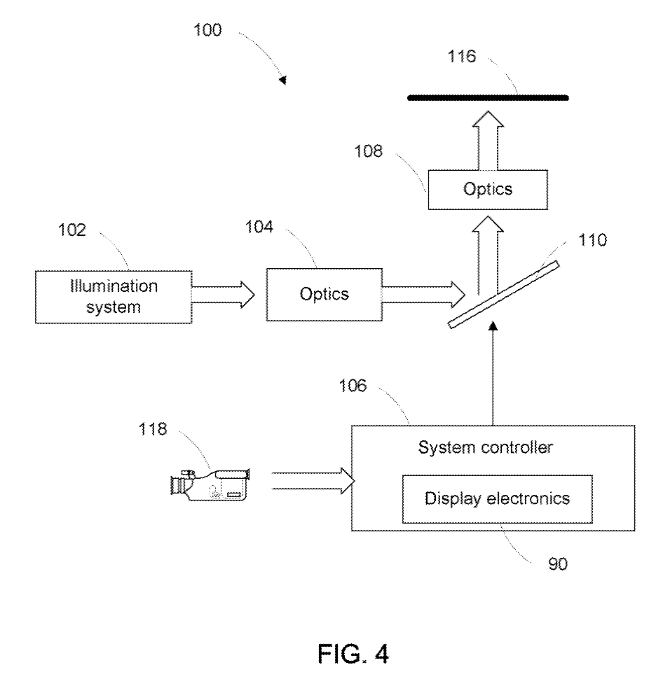

An exemplary display system in which examples disclosed herein can be implemented therein is schematically illustrated in FIG. 4. Referring to FIG. 4, display system 100 comprises illumination system 102 for providing illumination light for the system. The illumination light is collected and focused onto spatial light modulator 110 through optics 104. Spatial light modulator 110 that comprises an array of individually addressable pixels, such as micromirror devices, liquid-crystal-cells, and liquid-crystal-on-silicon cells modulates the illumination light under the control of system controller 106. The spatial light modulator can be replaced by other light valves, such as light valves having OLED cells, plasma cells or other suitable devices. In the later example wherein the light valves have light emissive pixels, the illumination system (102) may not be necessary. The modulated light is collected and projected to screen 116 by optics 108.

The system controller is designated for controlling and synchronizing functional elements of the display system. One of the multiple functions of the system controller is receiving input images (or videos) from an image source 118; and processing the input image. Specifically, the system controller may have display electronics 90 as discussed above with reference to FIG. 3. The processed images are then delivered to spatial light modulator 110 for reproducing the input images.

Examples of image correction method as disclosed herein are also applicable to other application fields, such as image capture (e.g. in cameras). Image capture devices also use a plurality of optical elements or elements that may introduce geometric distortion to the captured images. In such systems, the distortion introduced by the optical elements need to be corrected after a gamut mapping process that may be performed by the image processing chain in these camera. These operations (e.g. gamut mapping and distortion correction) may be performed in software modules or in embedded electronic processors in the image capture devices.

It will be appreciated by those of skill in the art that a new and useful image correction method has been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

I claim:

1. A method for producing an image using an image producing system, comprising:
characterizing a geometric distortion of an image by an optical system;
creating a correction image that has a distortion complementary to the geometric distortion in the corresponding image; and
producing the image using the correction image component.

2. The method of claim 1, wherein the step of producing the image using the correction image component comprises:
producing the image using an array of individually addressable pixels that are reflective and deflectable micromirrors, liquid-crystal cells, liquid-crystal-on-silicon cells, or plasma cells.

3. The method of claim 1, wherein the step of producing the image using the correction image component comprises:
producing the image with a camera.

4. The method of claim 1, further comprising:
performing a Gamut mapping for the image before performing the step of creating a correction image component for each image component of the image.

5. The method of claim 4, further comprising:
deriving a set of bitplane data from the correction image; and
delivering the bitplane data to an array of individually addressable pixels to reproduce the image.

6. The method of claim 5, further comprising:
illuminating the individually addressable pixels that are reflective and deflectable micromirrors;
modulating the light with the bitplane data; and
directing the modulated light onto a screen.

7. The method of claim 1, wherein the image components of the image comprise a groups of different colors that are selected from red, green, blue, yellow, cyan, magenta, or white.

8. The method of claim 10, wherein the correction image component has a color that is selected from red, green, blue, yellow, cyan, magenta, or white.

9. The method of claim 1, wherein the correction image components are created by a warping engine that is a software module comprising a set of computer-executable instructions, or by a warping engine that is an electronic circuit.

10. The method of claim 9, wherein the electronic circuit is a field-programmable-gate-array circuit or an application-specific-integrated-circuit.

11. A computer-readable medium having a set of computer-executable instructions for performing a method for producing an image using an image producing system, wherein the method comprises:
characterizing a geometric distortion introduced to each image component of the image by the image producing system;
creating a correction image component for each image component of the image, wherein said correction image component has a distortion complementary to the geometric distortion in the corresponding image component; and
producing the image using the correction image component.

12. A device for use in an imaging system for correcting a geometric distortion introduced by the imaging system, comprising:
an image warping engine capable of creating a correction image component for each image component of the image, wherein said correction image component has a distortion complementary to a geometric distortion in the corresponding image component introduced by the system during imaging.

13. The device of claim 12, further comprising:
a gamut mapping unit for converting a color space of the image into a color space of the system, wherein the image warping engine is connected to an output of the gamut mapping unit.

14. The device of claim 13, wherein the warping engine is a software module comprising a set of computer-executable instructions or an electronic circuit.

15. The device of claim 13, wherein the warping engine is an electronic circuit that is a field-programmable-gate-array circuit or an application-specific-integrated-circuit.

16. A display system for displaying an image, comprising:
an image engine having an array of individually addressable pixels; and
a control unit comprising a warping engine for creating a correction color image component for each color image component of the image, wherein said correction color image component has a distortion complementary to a geometric distortion in the corresponding color image component introduced by the system during imaging.

17. The system of claim 16, further comprising:
a gamut mapping unit for converting a color space of the image into a color space of the system, wherein the image warping engine is connected to an output of the gamut mapping unit.

18. The system of claim 26, wherein the warping engine is an electronic circuit that is a field-programmable-gate-array circuit or an application-specific-integrated-circuit.

19. A method for displaying an image, comprising:
displaying an image having a second shape from an array of pixels arranged in a first shape, where the array of pixels is an array of light emitting pixels or light modulating pixels;
providing data to the pixels such that the second shape of the displayed image is substantially the same as the first shape of the array of pixels.

20. A method for displaying an image, comprising:
displaying an image having a second shape from an array of pixels arranged in a first shape, where the array of pixels is an array of light emitting pixels or light modulating pixels;
providing data to the pixels such that a subgroup of pixels are turned off such that the second shape of the displayed image is closer to the shape of the entire pixel array than if the data was not provided.

21. A method for displaying an image, comprising:
providing light from an array of pixels arranged in a rectangle;
providing modulation data to a subgroup of the array of pixels such that only the subgroup is modulated with image data, wherein the subgroup are disposed in a geometric shape that is not a rectangle, and wherein the light beam from the subgroup of pixels has a corresponding shape that is not a rectangle;
directing the modulated light through an optical engine so as to change the cross section of the light beam from the subgroup of pixels, such that when the light beam is incident on a target for viewing by a viewer, the shape of the viewed image is substantially rectangular.

22. A method for displaying an image on a target, comprising:
providing a series of light beams of different colors onto a spatial light modulator;
modulating a subgroup of pixels of the spatial light modulator with image data for each color of the series of light beams;
wherein the subgroup of pixels for a first color has a different shape than the subgroup of pixels for a second color.

23. The method of claim 22, wherein the subgroup of pixels for the first and second colors have the same shape and size when displayed on a viewing target.

24. The method of claim 23, wherein the subgroups of pixels for the first and second colors are non-rectangular, and wherein the viewed image formed by a combination of the first and second colors is rectangular due to warping of the light beam during transmission through an optical element within the path of the light beam.
